(19) United States
(12) Patent Application Publication
(10) Pub. No.: US 2024/0416442 A1
(43) Pub. Date: Dec. 19, 2024

(54) MACHINE AND PROCESS FOR FORMING AN AXLE SHAFT

(71) Applicant: Federal Screw Works, Romulus, MI (US)

(72) Inventors: Aaron J. ZurSchmiede, East Grand Rapids, MI (US); David A. Bartell, Big Rapids, MI (US)

(73) Assignee: Federal Screw Works, Romulus, MI (US)

(21) Appl. No.: 18/210,810

(22) Filed: Jun. 16, 2023

(51) Int. Cl. B23F 1/06

(52) U.S. Cl. CPC B23F 1/06

(57) ABSTRACT

A machine for forming an axle shaft includes a plurality of stations and a conveyor for transferring an axle shaft preform in a horizontal orientation between the plurality of stations. The plurality of stations includes a first hobbing station that has a hobbing unit and a holding unit. The holding unit includes a rotator for rotating the axle shaft preform and the hobbing unit includes a cutting tool and a linkage that is configured to articulate the cutting tool vertically to engage the axle shaft preform and horizontally to define a length and depth of a removed material. The rotator is configured to rotate the axle shaft preform between each articulation of the cutting tool.

### FIELD OF THE DISCLOSURE

The present disclosure generally relates to a machine for forming an axle shaft. More specifically, the present disclosure relates to a machine with a plurality of stations for forming an axle shaft preform into an operable axle shaft.

### BACKGROUND OF THE INVENTION

Manufacturing techniques of axle shafts have been driven by perpetually evolving vehicular architecture and market forces. Typical manufacturing techniques involve a multi-location process within a manufacturing environment that require transporting an axle shaft preform between various machines for processing steps. These typical manufacturing techniques require significant human intervention between receiving an axle shaft preform and finalizing the axle shaft preform into an operable axle shaft. For example, oftentimes, the axle shaft preform must be oriented vertically for certain processing steps and in other orientations for additional processing steps. These changes in orientation of the axle shaft preform and human intervention requirements may increase cost, complexity, and timing of forming a finalized axle shaft.

Accordingly, there is a continuing desire to reduce the amount of human intervention required, complexity, and costs in manufacturing an axle shaft.

### SUMMARY OF THE INVENTION

According to one aspect of the present disclosure, a machine for forming an axle shaft includes a plurality of stations and a conveyor for transferring an axle shaft preform in a horizontal orientation between the plurality of stations. The plurality of stations includes a first hobbing station that has a hobbing unit and a holding unit. The holding unit includes a rotator for rotating the axle shaft preform, and the hobbing unit includes a cutting tool and a linkage that is configured to articulate the cutting tool vertically to define a depth of a removed material in the axle shaft preform and horizontally to define a length of the removed material. The rotator is configured to rotate the axle shaft preform between each articulation of the cutting tool.

According to another aspect of the present disclosure, a machine for forming an axle shaft includes a plurality of stations and a conveyor for transferring an axle shaft preform linearly between the plurality of stations. The plurality of stations includes a centering station with a dimpler configured to form a dimple on a first end face and a second end face of the axle shaft preform. A shaping station includes a reducer tool configured to reduce an outer diameter on sections of the axle shaft preform. A grooving station includes a groover tool configured to reduce an outer diameter adjacent to the first end face and the second end face. At least one hobbing station includes a cutting tool configured to form splines on the axle shaft preform.

According to yet another aspect of the present disclosure, a method of forming an axle shaft includes conveying an axle shaft preform to a first hobbing station. At the first hobbing station, the method includes simultaneously rotating the axle shaft preform about a horizontal axis and cutting splines that are substantially parallel to the horizontal axis on a first side of the axle shaft preform. The axle shaft preform is then conveyed to a second hobbing station. At the second hobbing station, the method includes simultaneously rotating the axle shaft preform about the horizontal axis and cutting splines that are substantially parallel to the horizontal axis on a second side of the axle shaft preform.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a top perspective view of a machine for forming an axle shaft in accordance with one aspect of the present disclosure;

FIG. 2 is a schematic top view of a machine for forming an axle shaft in accordance with one aspect of the present disclosure;

FIG. 3 is a side view of an axle shaft formed from a machine in accordance with one aspect of the present disclosure;

FIG. 4 is a top schematic top view of a machine and a method flow chart for forming an axle shaft in accordance with one aspect of the present disclosure; and

FIG. 5 is a method flow chart for forming an axle shaft in accordance with one aspect of the present disclosure.

### DETAILED DESCRIPTION

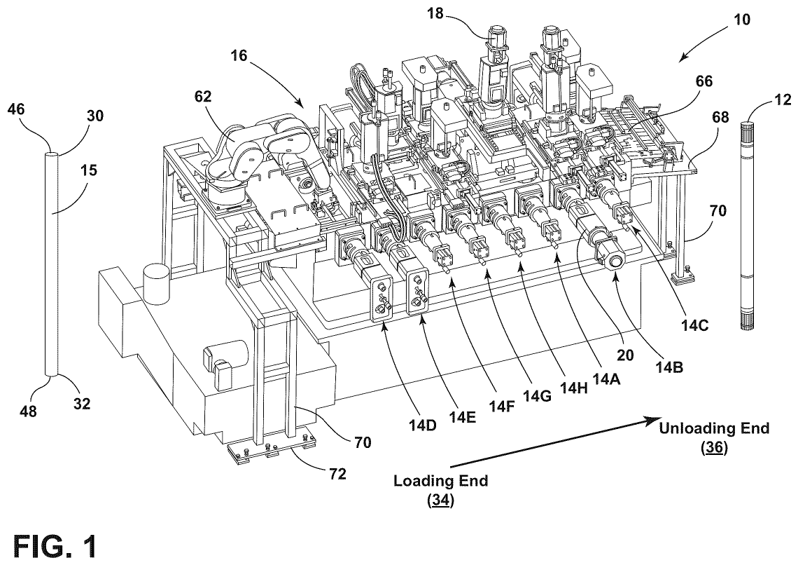

For purposes of description herein, the terms “upper,” “lower,” “right,” “left.” “rear.” “front.” “vertical,” “horizontal,” and derivatives thereof shall relate to the concepts as oriented in FIG. 1, and, more particularly, within the context of a manufacturing environment. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a machine with a plurality of stations for forming an axle shaft preform into an operable axle shaft. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a component is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising.” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

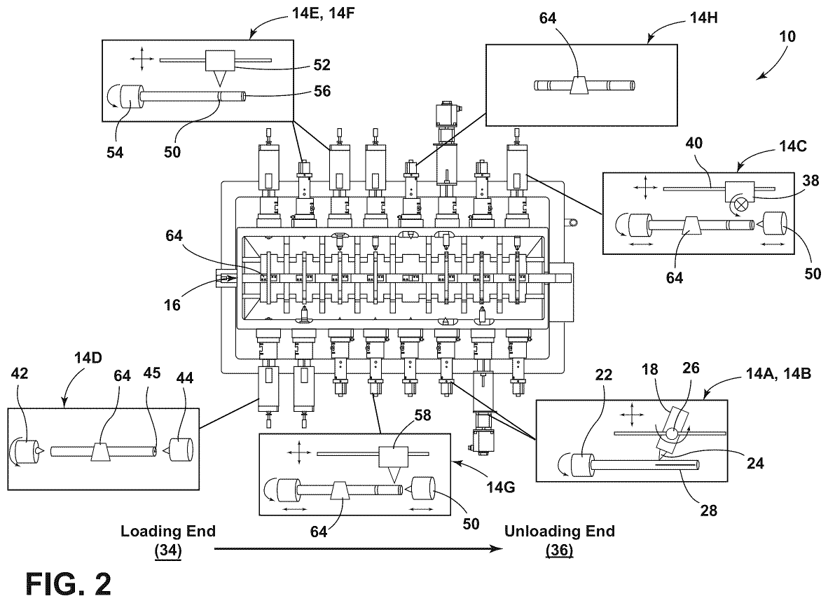

With reference initially to FIGS. 1 and 2, reference numeral 10 generally designates a machine for forming an axle shaft 12. The machine 10 includes a plurality of stations 14A-14H and a conveyor 16 for transferring an axle shaft preform 15 in a horizontal orientation between the plurality of stations 14A-14H. The plurality of stations 14A-14H includes a first hobbing station 14A that has a hobbing unit 18 and a holding unit 20. The holding unit 20 includes a rotator 22 for rotating the axle shaft preform 15, and the hobbing unit 18 includes a cutting tool 24 and a linkage 26 (FIG. 2) that is configured to articulate the cutting tool 24 vertically to engage the axle shaft preform 15 and horizontally to define a length and depth of a removed material 28. The rotator 22 is configured to rotate the axle shaft preform 15 between each articulation of the cutting tool 24.

With continued reference to FIGS. 1-3, the rotator 22 may be further configured to rotate the axle shaft preform 15 during each articulation of the cutting tool 24 to at least partially define a width of the removed material 28. In some embodiments, the removed material 28 defines a plurality of splines on the axle shaft preform 15. The machine 10 may further include a second hobbing station 14B that also includes one of the hobbing units 18 and holding units 20. The hobbing unit 18 of the first hobbing station 14A is located in proximity to a first end 30 of the axle shaft preform 15, and the hobbing unit 18 of the second hobbing station 14B is located in proximity to a second end 32 of the axle shaft preform 15. The conveyor 16 is configured to move the axle shaft preform 15 linearly between each of the plurality of stations 14A-14H. The conveyor 16 extends from a loading end 34 where the axle shaft preform 15 is initially provided and an unloading end 36 wherein the axle shaft 12 has been machined into an operable state. In some embodiments, the first hobbing station 14A and the second hobbing station 14B are linearly aligned. In other embodiments, the first hobbing station 14A and the second hobbing station 14B are linearly misaligned such that the axle shaft preform 15 is transferred (i.e., by the conveyor) from the first hobbing station 14A to the second hobbing station 14B.

With reference now to FIGS. 1-3, the plurality of stations 14A-14H further includes a deburring station 14C for removing burs in proximity to the removed material 28 of the axle shaft preform 15. In this manner, the deburring station 14C may be located closer to the unloading end 36 than the hobbing station 14A and the second hobbing station 14B. In some embodiments, the deburring station 14C is located closer to the unloading end 36 than any of the other stations 14A-14B and 14D-14H. The deburring station 14C includes a grinding tool 38 that moves (e.g., rotates) relative to the axle shaft preform 15. The grinding tool 38 may be connected to a track linkage 40 that moves the grinding tool 38 horizontally and/or vertically between the first end 30 and the second end 32 of the axle shaft preform 15 (e.g., perpendicularly to the movement of the conveyor 16). In this manner, the grinding tool 38 may de-bur substantially the entire axle shaft preform 15. In some embodiments, the clamp member 64 and/or pinch units 50 are configured to rotate the axle shaft preform 15 in conjunction with rotation of the grinding tool 38 (e.g., in the same or opposite directions).

The plurality of stations 14A-14H further includes a centering station 14D for locating the axle shaft preform 15 in the horizontal orientation on the loading end 34 of the conveyor 16. The centering station 14D includes a first dimpler 42 located in proximity to a first end 30 of the axle shaft preform 15 and a second dimpler 44 located in proximity to a second end 32 of the axle shaft preform 15. The first and second dimplers 42, 44 are respectively configured to form dimples 45 on a first end face 46 located on the first end 30 and a second end face 48 located on the second end 32 of the axle shaft preform 15. The dimplers 42 may each include a conically-shaped bit defining an outward angle. The outward angle may be between about 30° and 90°, for example, between about 45° and 75°, or about 60°. In this manner, each dimple 45 may be conically shaped with the outward angle. Each and/or select of the stations 14A-14H may include a pair of pinch units 50. Each pair of pinch units 50 includes a pinch unit 50 located in proximity to the first end 30 of the axle shaft preform 15 and a pinch unit 50 located in proximity to the second end 32 of the axle shaft preform 15. The pinch units 50 are configured to selectively hold the axle shaft preform 15 via insertion into the dimples 45. More particularly, each pair of pinch units 50 includes an extended position where the pinch units 50 are located in the dimples 45 and a retracted position where the pinch units 50 are removed from the dimples 45. Because the dimples 45 are conically shaped, the pinch units 50 both selectively hold and center the axle shaft preform 15 at each station 14A-14H.

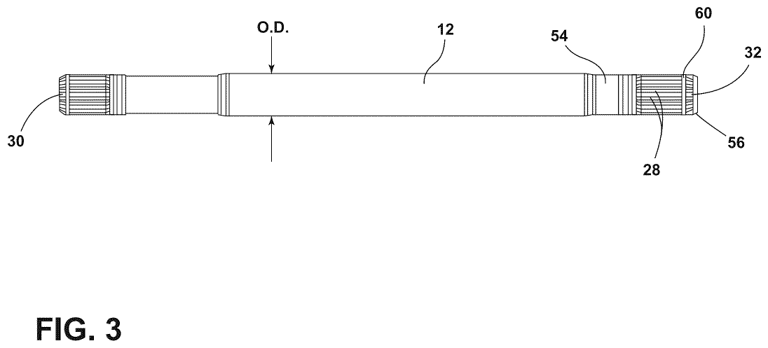

With continued reference to FIGS. 1-3, the plurality of stations 14A-14H further includes a first shaping station 14E located proximate the first end 30 with a reducer tool 52 (e.g., a lathe) configured to reduce an outer diameter (“O.D.”) on sections of the axle shaft preform 15 proximate the first end 30. More particularly, one or more grooves 54 are formed on the O.D. and a chamfer 56 is formed on the first end face 46. A second shaping station 14F is located proximate the second end 32 and also includes one of the reducer tools 52 configured to reduce an O.D. on sections of the axle shaft preform 15 proximate the second end 32 to form additional grooves 54 and a chamfer 56 on the second end face 48. The plurality of stations 14A-14H further includes a grooving station 14G with a groover tool 58 (e.g., a blade, grinder, or lathe) configured to form annular depressions 60 by reducing an outer diameter adjacent to the first end face 46 and the second end face 48. The grooves 54, the chamfers 56, and the annular depressions 60 (FIG. 3) may be utilized to facilitate connection of a boot (not shown) or other components of a vehicle during integration. Likewise, certain grooves 54 may be formed to reduce the weight of the axle shaft preform 15. The plurality of stations 14A-14H may further include a resting station 14H where the axle shaft preform 15 can be inspected and/or where the axle shaft preform 15 can cool prior to proceeding to manufacturing steps in the proceeding stations 14A-14H.

With reference now to FIGS. 1-2, a robotic arm 62 may be located near the loading end 34 that is configured to load the axle shaft preform 15 into the centering station 14D. The conveyor 16 runs centrally between stations, carrying the axle shaft preform 15 in a horizontal orientation between stations 14A-14H. More particularly, the conveyor 16 may include a series of clamping members 64 spaced from one another along the conveyor 16 a first distance. Each of the stations 14A-14H may be spaced from one another by a second distance that is equal to the first distance. The conveyor 16 may be an infinite, belt-type conveyor 16 with clamping members 64 spaced along an entire length of the belt. In this manner, two or more axle shaft preforms 15 may be located in different stations 14A-14H simultaneously. In some embodiments, the robotic arm 62 may be configured to add an additional axle shaft preform 15 every time the conveyor 16 completes transferring the axle shaft preform 15 to a subsequent station. As such, the machine 10 may be configured to have an axle shaft preform 15 at each station 14A-14H to maximize efficiency.

With continued reference to FIGS. 1-4, the unloading end 36 may include a receiving compartment 66 (FIG. 1) that collects axle shafts 12 that have traveled through each of the stations 14A-14H. The axle shafts 12 may be in an operable state, which may be simply defined as an axle shaft 12 that does not require any further machining or deburring prior to incorporation into a vehicle. For example, an axle shaft 12 in an operable state may require additional processes, such as polishing, chemical treatments, and/or the like. The machine 10 may be elevated on a frame 68 that includes legs 70 with mounting apertures 72 that receive fasteners for securing the frame 68 to a floor in a manufacturing environment. The plurality of stations 14A-14H may be located in a variety of orders along the conveyor 16. For example, the centering station 14D may be located adjacent to the loading end 34, the first and second hobbing stations 14A, 14B may be located adjacent to the unloading end 36, and the other stations 14C, 14E-14H may be located between the centering station 14D and the first and second hobbing stations 14A, 14B. In some embodiments, the first and second shaping stations 14E, 14F may be located adjacent to the centering station 14D, the grooving station 14G may be located adjacent to the first and second shaping stations 14E, 14F opposite the centering station 14D, and the resting station 14H may be located between the first and second shaping stations 14E, 14F and the first and second hobbing stations 14A, 14B. The machining components at each or select stations 14A-14H may be configured to operate by usage of negative feedback mechanisms, such as servos. For example, each hobbing station 14A, 14B may operate on a servo to control linear and rotational movement of hobbing units 18 and holding units 20 for precise control of material removal.

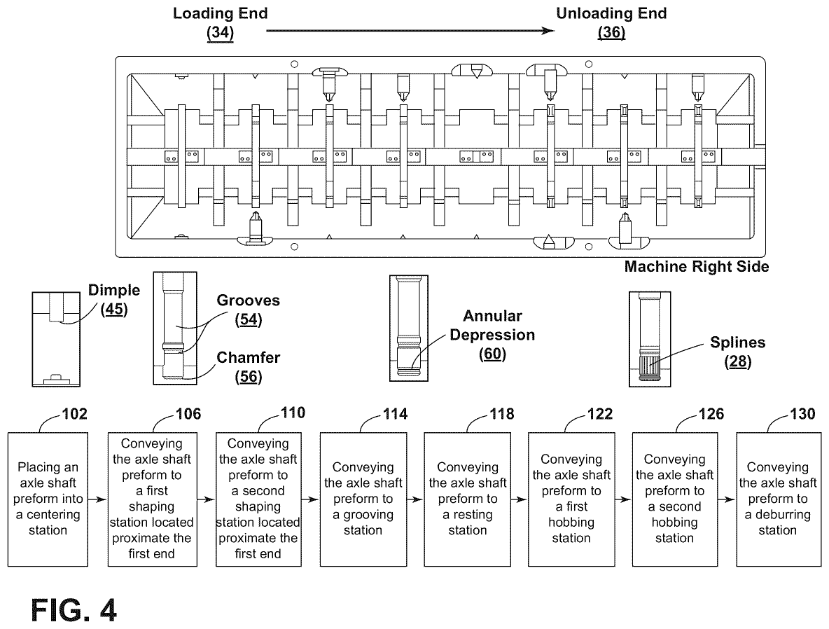

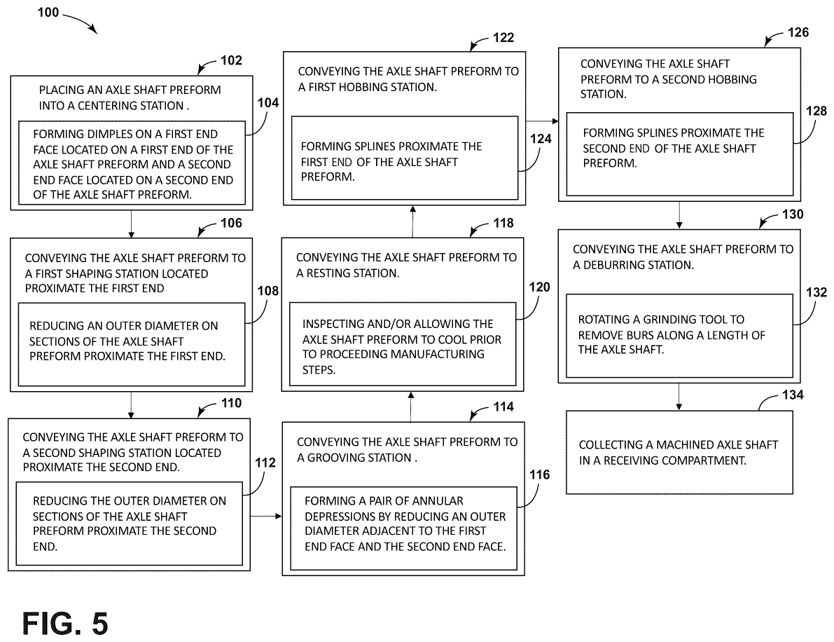

With reference now to FIGS. 4 and 5, a method 100 of forming an axle shaft 12 is provided. At 102, the method 100 includes placing an axle shaft preform 15 into a centering station 14D. For example, a robotic arm 62 may place the axle shaft preform 15 into the centering station 14D in a horizontal orientation. Step 102 may include, at step 104, forming dimples 45 on a first end face 46 located on a first end 30 of the axle shaft preform 15 and a second end face 48 located on a second end 32 of the axle shaft preform 15. For example, the centering station 14D may include a first dimpler 42 located in proximity to the first end 30 and a second dimpler 44 located in proximity to the second end 32. The dimples 45 may be conically shaped.

With continued reference to FIGS. 4-5, the method 100 may further include, at step 106, conveying the axle shaft preform 15 to a first shaping station 14E located proximate the first end 30. For example, the axle shaft preform 15 may be conveyed with a conveyor 16 that includes clamping members 64. Step 106 may include, at step 108, reducing an O.D. on sections of the axle shaft preform 15 proximate the first end 30. For example, a reducer tool 52 (e.g., a lathe) may form one or more grooves 54 on the O.D. and a chamfer 56 on the first end face 46. At step 110, conveying the axle shaft preform 15 to a second shaping station 14F located proximate the second end 32. For example, the axle shaft preform 15 may be conveyed with the conveyor 16 may convey the axle shaft preform 15 from the first shaping station 14E to the second shaping station 14F. Step 110 may include, at step 112, reducing the O.D. on sections of the axle shaft preform 15 proximate the second end 32. For example, the second shaping station 14F may further include a reducer tool 52 (e.g., a lathe) that may form one or more grooves 54 on the O.D. and another chamfer 56 on the second end face 48.

With continued reference to FIGS. 4-5, the method 100 may further include, at step 114, conveying the axle shaft preform 15 to a grooving station 14G. For example, the axle shaft preform 15 may be conveyed with a conveyor 16 from the second shaping station 14F to the grooving station 14G. Step 114 may include, at step 116, forming a pair of annular depressions 60 by reducing an outer diameter adjacent to the first end face 46 and the second end face 48. For example, the grooving station 14G may include a groover tool 58 (e.g., a blade, grinder, or lathe) configured to form annular depressions 60. The method 100 may further include, at step 118, conveying the axle shaft preform 15 to a resting station 14H. For example, the axle shaft preform 15 may be conveyed with the conveyor 16 from the grooving station 14G to the resting station 14H. Step 118 may include, at step 120, inspecting and/or allowing the axle shaft preform 15 to cool prior to proceeding with additional manufacturing steps.

With continued reference to FIGS. 4 and 5, the method 100 may further include, at step 122, conveying the axle shaft preform 15 to a first hobbing station 14A. For example, the axle shaft preform 15 may be conveyed with the conveyor 16 from the resting station 14H to the first hobbing station 14A. Step 122 may include, at step 124, forming splines proximate the first end 30 of the axle shaft preform 15. For example, step 124 may include simultaneously rotating (e.g., with a rotator 22 of a hobbing unit 18) the axle shaft preform 15 about a horizontal axis and cutting splines (e.g., with a cutting tool 24 and a linkage 26 that is configured to articulate the cutting tool 24) that are substantially parallel to the horizontal axis on a first side of the axle shaft preform 15. The method 100 may further include, at step 126, conveying the axle shaft preform 15 to a second hobbing station 14B. For example, the axle shaft preform 15 may be conveyed with the conveyor 16 from the first hobbing station 14A to the second hobbing station 14B. Step 126 may include, at step 128, forming splines proximate the second end 32 of the axle shaft preform 15. For example, step 128 may include simultaneously rotating (e.g., with a rotator 22 of a hobbing unit 18) the axle shaft preform 15 about a horizontal axis and cutting splines (e.g., with a cutting tool 24 and a linkage 26 that is configured to articulate the cutting tool 24) that are substantially parallel to the horizontal axis on a first side of the axle shaft preform 15.

With continued reference to FIGS. 4 and 5, the method 100 may further include, at step 122, conveying the axle shaft preform 15 to a deburring station 14C. For example, the axle shaft preform 15 may be conveyed with the conveyor 16 from the second hobbing station 14B to the deburring station 14C. The deburring station 14C may include a grinding tool 38 connected to a track linkage 40 that moves the grinding tool 38 horizontally and/or vertically between the first end 30 and the second end 32 of the axle shaft preform 15. In some embodiments, the clamp member 64 and/or pinch units 50 are configured to rotate the axle shaft preform 15 in conjunction with rotation of the grinding tool 38. Step 130 may include, at step 132, rotating a grinding tool 38 to remove burs along a length of the axle shaft 12. The method 100 may further include, at step 134, collecting a machined axle shaft 12 in a receiving compartment 66.

With continued reference to FIGS. 4 and 5, the method 100 may further include at each of stations 14A-14H, holding the axle shaft preform 15 by the dimples 45. For example, pairs of pinch units 50 may be configured to selectively hold the axle shaft preform 15 via insertion into the dimples 45. More particularly, articulating the pinch units 50 between an extended position where the pinch units 50 are located in the dimples 45 and a retracted position where the pinch units 50 are removed from the dimples 45. Because the dimples 45 are conically shaped, the pinch units 50 both selectively hold and center the axle shaft preform 15 at each station 14A-14H.

Modifications of the disclosure will occur to those skilled in the art and to those who make or use the concepts disclosed herein. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

The invention disclosed herein is further summarized in the following paragraphs and is further characterized by combinations of any and all of the various aspects described therein.

According to one aspect of the present disclosure, a machine for forming an axle shaft includes a plurality of stations and a conveyor for transferring an axle shaft preform in a horizontal orientation between the plurality of stations. The plurality of stations includes a first hobbing station that has a hobbing unit and a holding unit. The holding unit includes a rotator for rotating the axle shaft preform, and the hobbing unit includes a cutting tool and a linkage that is configured to articulate the cutting tool vertically to engage the cutting tool with the axle shaft preform and horizontally to define a length and a depth of a removed material. The rotator is configured to rotate the axle shaft preform between each articulation of the cutting tool.

According to another aspect of the present disclosure, a rotator is further configured to rotate an axle shaft preform during each articulation of a cutting tool to at least partially define a width of a removed material.

According to yet another aspect of the present disclosure, a removed material defines a plurality of splines on an axle shaft preform.

According to still another aspect of the present disclosure, a second hobbing station includes a hobbing unit and a holding unit, where the hobbing unit of a first hobbing station is located in proximity to a first end of an axle shaft preform and the hobbing unit of a second hobbing station is located in proximity to a second end of the axle shaft preform.

According to another aspect of the present disclosure, a conveyor is further configured for transferring an axle shaft preform linearly from a first hobbing station to a second hobbing station.

According to yet another aspect of the present disclosure, a plurality of stations comprises a deburring station for removing burs in proximity to the removed material of the axle shaft preform, the deburring station including a grinding tool connected to a track linkage that moves the grinding tool horizontally with respect to the axle shaft preform.

According to still another aspect of the present disclosure, a plurality of stations further comprises a centering station for locating an axle shaft preform in a horizontal orientation on a conveyor.

According to another aspect of the present disclosure, a centering station includes a first dimpler located in proximity to a first end of an axle shaft preform and a second dimpler located in proximity to a second end of the axle shaft preform, where the dimplers are respectively configured to form dimples on a first end face and a second end face of the axle shaft preform.

According to yet another aspect of the present disclosure, each pair of pinch units includes a pinch unit located in proximity to a first end of an axle shaft preform and a pinch unit located in proximity to a second end of the axle shaft preform. The pinch units at each of a plurality of stations are configured to selectively hold the axle shaft preform via insertion into dimples.

According to still another aspect of the present disclosure, each dimple and each pinch unit are conically shaped.

According to another aspect of the present disclosure, a machine for forming an axle shaft includes a plurality of stations and a conveyor for transferring an axle shaft preform linearly between the plurality of stations. The plurality of stations includes a centering station with a dimpler configured to form a dimple on a first end face and a second end face of the axle shaft preform. A shaping station includes a reducer tool configured to reduce an outer diameter on sections of the axle shaft preform. A grooving station includes a groover tool configured to reduce an outer diameter adjacent to the first end face and the second end face. At least one hobbing station includes a cutting tool configured to form splines on the axle shaft preform.

According to yet another aspect of the present disclosure, a robotic arm is configured to load an axle shaft preform into a centering station.

According to still another aspect of the present disclosure, a robotic arm is further configured to load a plurality of provided axle shaft preforms with a different provided axle shaft preform being simultaneously in each station.

According to another aspect of the present disclosure, a plurality of stations further comprises a deburring station for removing burs in proximity to the removed material of the axle shaft preform, the deburring station including a grinding tool connected to a track linkage that moves the grinding tool horizontally with respect to the axle shaft preform.

According to yet another aspect of the present disclosure, at least one hobbing station further comprises a first hobbing station in proximity to a first side of an axle shaft preform and a second hobbing station in proximity to a second side of the axle shaft preform.

According to still another aspect of the present disclosure, at least one hobbing station further comprises a linkage configured to articulate a cutting tool vertically to engage an axle shaft preform and horizontally to define a length and depth of a removed material.

According to another aspect of the present disclosure, at least one hobbing station further comprises a rotator configured to rotate an axle shaft preform between each articulation of a cutting tool.

According to yet another aspect of the present disclosure, a method of forming an axle shaft includes conveying an axle shaft preform to a first hobbing station. At the first hobbing station, the method includes simultaneously rotating the axle shaft preform about a horizontal axis and cutting splines that are substantially parallel to the horizontal axis on a first side of the axle shaft preform. The axle shaft preform is then conveyed to a second hobbing station. At the second hobbing station, the method includes simultaneously rotating the axle shaft preform about the horizontal axis and cutting splines that are substantially parallel to the horizontal axis on a second side of the axle shaft preform.

According to still another aspect of the present disclosure, a method of forming an axle shaft further comprises placing an axle shaft preform into a centering station and forming a dimple on a first end face and a second end face of the axle shaft preform.

According to another aspect of the present disclosure, the method of forming an axle shaft preform further comprises conveying the axle shaft preform to a deburring station and the deburring station includes a grinding tool. At the deburring station, moving the grinding tool horizontally into engagement with the axle shaft preform and rotating the grinding tool and the axle shaft preform in opposite directions.

It will be understood by one having ordinary skill in the art that construction of the described concepts, and other components, is not limited to any specific material. Other exemplary embodiments of the concepts disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A machine for forming an axle shaft, comprising:
a plurality of stations; and
a conveyor for transferring an axle shaft preform in a horizontal orientation between the plurality of stations,
wherein the plurality of stations comprises a first hobbing station including a hobbing unit and a holding unit,
wherein the holding unit comprises a rotator for rotating the axle shaft preform,
wherein the hobbing unit comprises a cutting tool and a linkage configured to articulate the cutting tool vertically to engage the cutting tool with the axle shaft preform and horizontally to define a length and a depth of a removed material, and
further, wherein, the rotator is configured to rotate the axle shaft preform between each articulation of the cutting tool.

2. The machine from claim 1, wherein the rotator is further configured to rotate the axle shaft preform during each articulation of the cutting tool to at least partially define a width of the removed material.

3. The machine from claim 2, wherein the removed material defines a plurality of splines on the axle shaft preform.

4. The machine from claim 2, further including a second hobbing station including a hobbing unit and a holding unit, wherein the hobbing unit of the first hobbing station is located in proximity to a first end of the axle shaft preform and the hobbing unit of the second hobbing station is located in proximity to a second end of the axle shaft preform.

5. The machine from claim 4, wherein the conveyor is further configured for transferring the axle shaft preform linearly from the first hobbing station to the second hobbing station.

6. The machine from claim 1, wherein the plurality of stations further comprises a deburring station for removing burs in proximity to the removed material of the axle shaft preform, the deburring station including a grinding tool connected to a track linkage that moves the grinding tool horizontally with respect to the axle shaft preform.

7. The machine from claim 1, wherein the plurality of stations further comprises a centering station for locating the axle shaft preform in the horizontal orientation on the conveyor.

8. The machine from claim 7, wherein the centering station includes a first dimpler located in proximity to a first end of the axle shaft preform and a second dimpler located in proximity to a second end of the axle shaft preform, wherein the dimplers are respectively configured to form dimples on a first end face and a second end face of the axle shaft preform.

9. The machine from claim 8, further comprising:
pairs of pinch units, each pair including a pinch unit located in proximity to the first end of the axle shaft preform and a pinch unit located in proximity to the second end of the axle shaft preform, the pinch units at each of the plurality of stations configured to selectively hold the axle shaft preform via insertion into the dimples.

10. The machine from claim 9, wherein each dimple and each pinch unit is conically shaped.

11. A machine for forming an axle shaft, comprising:
a plurality of stations; and
a conveyor for transferring an axle shaft preform linearly between the plurality of stations,
wherein the plurality of stations comprises:
a centering station with a dimpler configured to form a dimple on a first end face and a second end face of the axle shaft preform,
a shaping station with a reducer tool configured to reduce an outer diameter on sections of the axle shaft preform,
a grooving station with a groover tool configured to reduce an outer diameter adjacent to the first end face and the second end face, and
at least one hobbing station comprising a cutting tool configured to form splines on the axle shaft preform.

12. The machine from claim 11, wherein a robotic arm is configured to load the axle shaft preform into the centering station.

13. The machine from claim 12, wherein the robotic arm is further configured to load a plurality of provided axle shaft preforms with a different provided axle shaft preform being simultaneously in each station.

14. The machine from claim 11, wherein the plurality of stations further comprises a deburring station for removing burs in proximity to a removed material of the axle shaft preform, the deburring station including a grinding tool connected to a track linkage that moves the grinding tool horizontally with respect to the axle shaft preform.

15. The machine from claim 11, wherein the at least one hobbing station further comprises a first hobbing station in proximity to a first side of the axle shaft preform and a second hobbing station in proximity to a second side of the axle shaft preform.

16. The machine from claim 11, wherein the at least one hobbing station further comprises a linkage configured to articulate the cutting tool vertically to engage the axle shaft preform and horizontally to define a length and depth of a removed material.

17. The machine from claim 16, wherein the at least one hobbing station further comprises a rotator configured to rotate the axle shaft preform between each articulation of the cutting tool.

18. A method of forming an axle shaft, the method comprising the steps of:
conveying an axle shaft preform to a first hobbing station;
at the first hobbing station, simultaneously rotating the axle shaft preform about a horizontal axis and cutting splines that are substantially parallel to the horizontal axis on a first side of the axle shaft preform;
conveying the axle shaft preform to a second hobbing station; and
at the second hobbing station, simultaneously rotating the axle shaft preform about the horizontal axis and cutting splines that are substantially parallel to the horizontal axis on a second side of the axle shaft preform.

19. The method of claim 18, further comprising placing an axle shaft preform into a centering station and forming a dimple on a first end face and a second end face of the axle shaft preform.

20. The method of claim 19, further comprising;
conveying the axle shaft preform to a deburring station, the deburring station including a grinding tool;
moving the grinding tool horizontally into engagement with the axle shaft preform; and
rotating the grinding tool and the axle shaft preform in opposite directions.
